(19) United States
(12) Patent Application Publication
(10) Pub. No.: US 2008/0258499 A1
(43) Pub. Date: Oct. 23, 2008

(54) Cargo Trailer

(76) Inventor: William G. Cleaves, Liberty, ME (US)

Correspondence Address: BOHAN MATHERS, PO BOX 17707, PORTLAND, ME, 04112-8707, US

(21) Appl. No.: 11/871,407

(22) Filed: Oct. 12, 2007

Related U.S. Application Data
(60) Provisional application No. 60/851,154, filed on Oct. 12, 2006.

(51) Int. Cl. B62D 33/04

(52) U.S. Cl. 296/182.1

(57) ABSTRACT

Cargo trailer kit containing pre-fabricated ready-to-assemble modular components for a cargo trailer. The cargo box is assembled from a chassis with pre-installed floor, a plurality of wall panels, and a roof panel. Wall panels are captured top and bottom in two channels, one extending around the perimeter of the chassis and one around the perimeter of the roof panel, and secured via threaded fasteners to the chassis and roof frames. Trim pieces are attached to wall panels to seal joints between abutting panels. Signal lights are incorporated into appropriate components. A pre-assembled wheel assembly and a tow assembly are included in the kit, plus a wire harness for connecting the signal lights to the tow vehicle power supply. The cargo trailer is easily assembled with general assembly tools. The cargo trailer kit allows a complete cargo trailer to be shipped in a stackable, compact bundle.

### BACKGROUND INFORMATION

1. Field of the Invention

The invention relates to field of cargo trailers. More particularly, the invention relates to a method of making and assembling a cargo trailer having a metal frame.

2. Description of the Prior Art

Cargo trailers are used to tow cargo or equipment behind a powered vehicle. Trailers intended to haul costly items or heavy equipment are constructed as rugged trailers, having at least a rugged metal chassis. Typically, such trailers are closed containers and, if intended to haul a particular item of cargo or equipment, they may be specially outfitted to accommodate the item in the most efficient and safest manner. Hereinafter the term “cargo trailer” shall be used to refer to enclosed trailers that have a metal chassis and are used to haul cargo or equipment.

Throughout the cargo trailer industry, cargo trailers are manufactured, shipped to dealers, and sold to consumers as completely assembled units. This has disadvantages. Shipping costs are determined by the volume of the goods to be shipped. The cargo trailer as shipped is usually empty. Thus, the greatest portion of the volume being shipped is useless space and serves only to increase the cost of the shipping.

The reason that cargo trailers are shipped as completely assembled units lies in the conventional method of construction. The manufacturing process begins with a steel or aluminum chassis being bolted to an axle, which is mounted on a set of wheels. Frames for the sides, front, and back panels of the trailer are then welded or otherwise attached to the chassis, and the roof then welded to the top of the frames to complete the framing for the trailer. The next step is to install wiring in the frames. After the wiring is installed, the floor is placed the chassis, exterior panels are then attached to the frames for the sides and the roof that form a box. Interior panels, and, if required, insulation are then installed on the inside of the box. Finally, exterior lights are installed and trim and fenders attached to the outer panels. Door hinges are mounted on the rear frame and door panels mounted, paneled, insulated, and trimmed.

This manufacturing process is inefficient, in that multiple and very different work steps are performed at a particular area of the trailer. For example, during the assembly process, bar stock is welded together to form the chassis and the side-wall frames, wiring, exterior paneling, insulation, and interior paneling are all assembled on each side of the box. This requires that a large quantity and variety of material be present at the work site, or that the assembly worker travel back and forth to storage sites to fetch the necessary parts, welding equipment, mounting hardware, and tools. The process is inherently inefficient and costly with regard to labor and warehousing.

The completed trailer is stored in the manufacturer's inventory, shipped to dealers on flat bed trucks, and stored in dealers' lots for sale. Each trailer encloses a large volume of empty space, as well as occupies a significant ground area that is defined by the footprint of the box, plus the distance that the tow bar and trailer hitch extend from the box. Ground space is expensive and this use of space on a dealer's lot to show and store cargo trailers is costly.

What is needed, therefore, is a more economical method of constructing a cargo trailer. What is further needed is a cargo trailer assembly kit that allows significant economic savings in assembly, shipping, and storage.

### BRIEF SUMMARY OF THE INVENTION

The invention is a trailer kit comprising a bundled collection of easily assemblable pre-fabricated or pre-assembled components. All components are easily assembled with common assembly tools, such as screw drivers and wrenches. The trailer kit eliminates all or nearly all wasted space, both interior and exterior, that is occupied by the conventional assembled cargo trailer. Furthermore, the trailer kit is stackable, one on another, allowing multiple cargo trailer kits to be stored on the same footprint as a single kit and thereby increasing the number of cargo trailers that may be shipped at once on one flatbed or within a van or shipping container. This significantly reduces both storage and shipping volume, resulting in significant savings for manufacturers, shippers, and sellers.

The cargo trailer kit according to the invention comprises pre-fabricated components that include a floor, wall panels, and a roof, and which, when assembled, form the cargo “box.” Additional pre-assembled or ready-to-assemble components include a tow bar, an axle or axles, wheels, finish trim pieces, and all hardware needed for final assembly. The floor is a complete pre-fabricated chassis unit that includes flooring installed on a chassis frame, along with insulation as needed and appropriate, and any fixtures intended for accommodating specific equipment or cargo, such as moving vehicle signal lights. Likewise, the wall panels and the roof are each complete pre-fabricated units, each unit including a frame with an exterior panel or skin affixed to it. Insulation, an interior panel or skin, as well as lighting and other fixtures, may be included in the panel, as applicable and as desired. A wiring harness for connecting moving vehicle signal lights and any lighting fixtures to the tow vehicle power supply is also included. One of the wall panels is a rear access panel that includes a door. This rear access panel is also a completely pre-fabricated unit that includes a hinged door and the requisite door hardware. Each panel is finished with sealer, paint, or other finishes, depending on the particular model and intended use of the cargo trailer.

The pre-fabricated units are flat units that are stackable, one on top of the other. Placed on top of this stack of pre-fabricated units are additional components necessary to complete the cargo trailer, including hardware for assembly, such a nuts and bolts and other threaded fasteners, finish trim sheets, a tow bar, an axle assembly, and wheels pre-mounted with tires. The cargo trailer kit according to the invention contains all components to quickly and easily assemble a cargo trailer. General assembly tools, such as screw drivers and wrenches, are used to assemble the various units and components. The compact bundle allows multiple cargo trailers to be shipped and stored in a smaller footprint than the space required to ship or store a single assembled cargo trailer.

The chassis has a panel-receiving channel that extends around the two sides and the front of the box. The channel is constructed to receive the lower ends of the wall panels that form the box. The roof also has a channel for receiving the upper ends of the wall panels. The rear-access panel is affixed to the rear side of the chassis and has a support flange for supporting in the vertical dimension the side edges of the two panels that abut the rear-access panel. The side wall panels are fitted into the channel in the chassis and pushed up against the rear-access panel. The front wall panels are placed in the channel in the chassis, at the front of the box. The roof is then placed over the top of the panels, the upper edge of each side panel, front-wall panel, and rear-access panel fitting into the channel in the roof frame. The side and front panels are then secured to the chassis and the roof by bolting them or otherwise securing them to the respective roof and chassis frames. Trim panels are secured to the exterior surfaces of the panels where they abut together, thereby covering any opening between the panels. Sealer may be applied to the seams along the trim panels to prevent the ingress of moisture into the panels. Wheels are mounted on an axle, which is assembled on the bottom of the chassis. Wheel fenders are assembled to the side of the chassis. A tow assembly is mounted on the chassis, for hitching the cargo trailer to the tow hitch on the towing vehicle.

The frames for the chassis and the roof are formed from metal, preferably aluminum. Suitable sheet material is used for the exterior and interior panels, including the floor. For example, a thin metallic sheet may be used for the exterior panel, while a wood or wood fiber sheet material may be used for the interior panel and floor. Insulation may be incorporated into the frames, as desired.

### BRIEF DESCRIPTION OF THE DRAWINGS

The present invention is described with reference to the accompanying drawings. In the drawings, like reference numbers indicate identical or functionally similar elements.

FIG. 1 shows a side plane view of the cargo trailer according to the invention.

FIG. 2 shows a rear plane view of the cargo trailer according to the invention.

FIG. 3 is an exploded view of the trailer kit according to the invention, bundled and ready for shipping, storage, or assembly.

FIG. 4A illustrates the frame of a side panel.

FIG. 4B illustrates a finished, pre-fabricated side panel.

FIG. 5 is a cross-sectional view of the side panel of FIG. 4B.

FIG. 6A illustrates the frame of a front-wall panel.

FIG. 6B shows finished, pre-fabricated front-wall panels.

FIG. 7A illustrates the chassis frame with tow assembly attached.

FIG. 7B is a side view of the chassis frame and tow assembly.

FIG. 7C is a cross-sectional view of the channel member, showing the first wall-panel receiving channel and flooring.

FIG. 7D is a perspective view of the rear right corner of the chassis and the access mounting strut.

FIG. 8A is a cross-sectional view of the rear-end of the chassis, with access-mounting strut.

FIG. 8B shows the finished, pre-fabricated chassis.

FIG. 9A illustrates the frame for the roof panel.

FIG. 9B shows a finished, pre-fabricated roof panel.

FIG. 10 is a cross-sectional view of the roof panel, showing the second wall-panel receiving channel.

FIG. 10A is a cross-sectional view of the roof panel, showing an alternative embodiment of the exterior roof-frame member and the roof trim.

FIG. 11 is a perspective view of the rear access panel with drop-down door.

FIG. 12A is a cross-sectional illustration of the side beam with side-panel support flange.

FIG. 12B is a top view of the rear right corner of a partially assembled cargo trailer, showing the rear-access panel attached to the rear end of the chassis, without the door mounted in the rear-access panel.

FIG. 12C is a side elevational view of the rear right corner of FIG. 12B, showing the rear-access frame mounted on the chassis, with the side-panel support flange in place to support the rear end of the right side panel.

FIG. 13 shows a rub rail that secures the rear end of the side panels to the rear-access panel.

### DETAILED DESCRIPTION OF THE INVENTION

The present invention will now be described more fully in detail with reference to the accompanying drawings, in which an embodiment of the invention is shown. This invention should not, however, be construed as limited to the embodiment set forth herein; rather, they are provided so that this disclosure will be complete and will fully convey the scope of the invention to those skilled in the art.

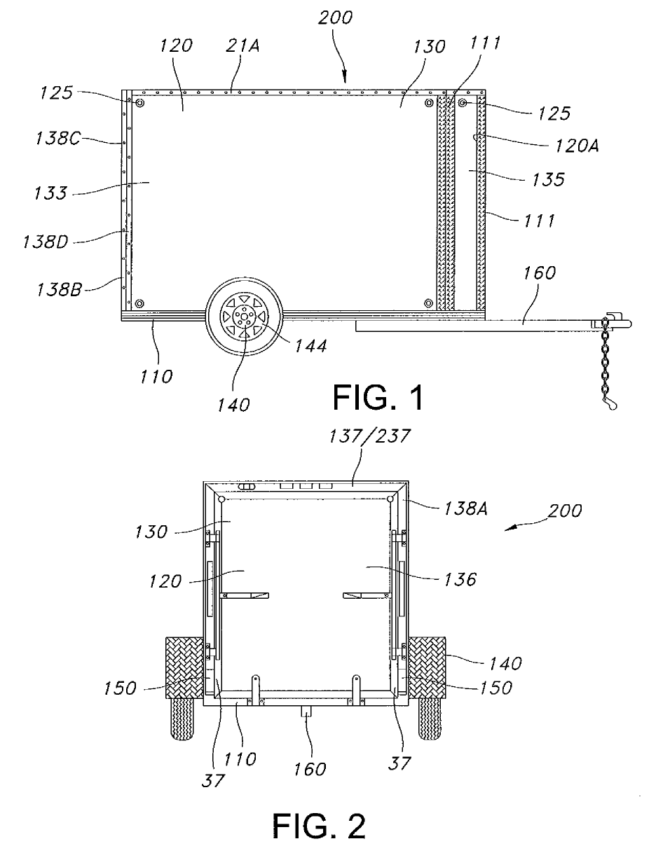

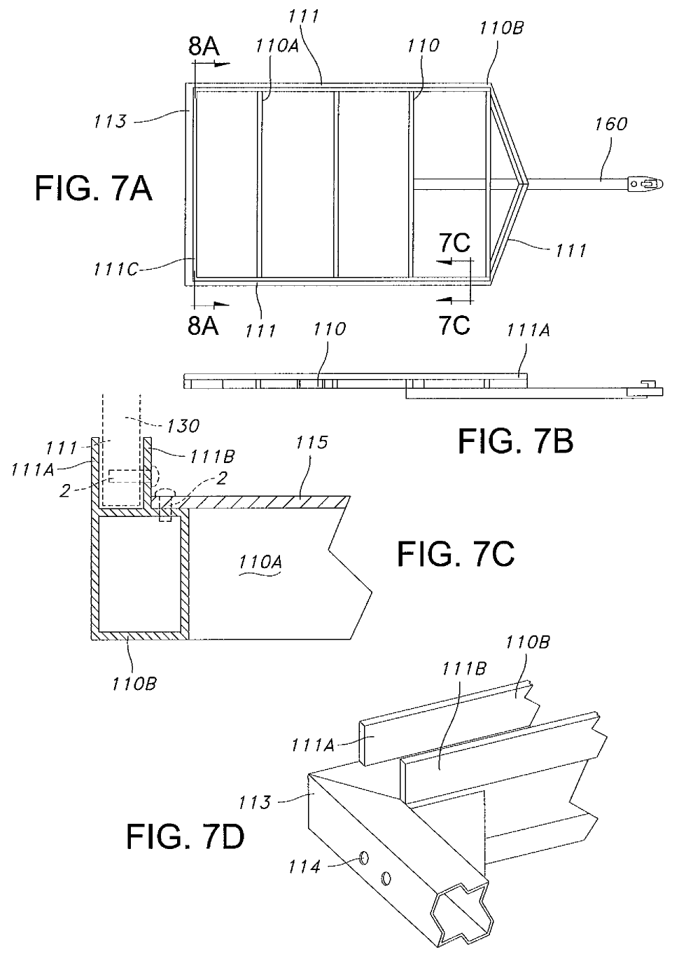

FIGS. 1 and 2 show a cargo trailer 200 according to the invention, completely assembled and ready for use. The cargo trailer 200 includes a container or box 120 mounted on a wheel assembly 140, and a tow assembly 160 for towing it behind a powered vehicle. The box 120 provides a closed container that is made up of a chassis 110, a rear access panel 136, a roof panel 137, and wall panels 130 that form the sides of the box 120. Moving vehicle signal lights 150, such as brake lights and directionals, are provided on the appropriate panels. In the embodiment shown, the box 120 has an aerodynamically angled front end 120A and is otherwise rectangular in shape, as is best seen in the shape of the chassis in FIG. 7A. The wall panels 130 include a left side panel 132, a right side panel 133, a left front panel 134, a right front panel 135. The particular shape of the cargo trailer 200 is not, however, limited to that shown in these figures, but may be any other useful shape. Another suitable shape for the box 120, for example, is a straightforward rectangular shape, i.e., a box without the angled front end.

FIG. 3 is an exploded view, showing a cargo trailer kit 100 according to the invention, which comprises pre-fabricated modular components that are readily assemblable to the cargo trailer 200. This exploded view illustrates how the modular components may be bundled together, for shipping, storing, or assembly. The cargo trailer kit 100 shows the components for the box 120, stacked one on top of the other, as well as the components for the wheel assembly 140 and the tow assembly 160, which are shown placed on top of the box components. This figure is provided for illustration purposes only, to give an idea of how the cargo trailer kit 100 may be bundled for shipping, and may not be complete, that is, it may not show every component of the cargo trailer kit 100.

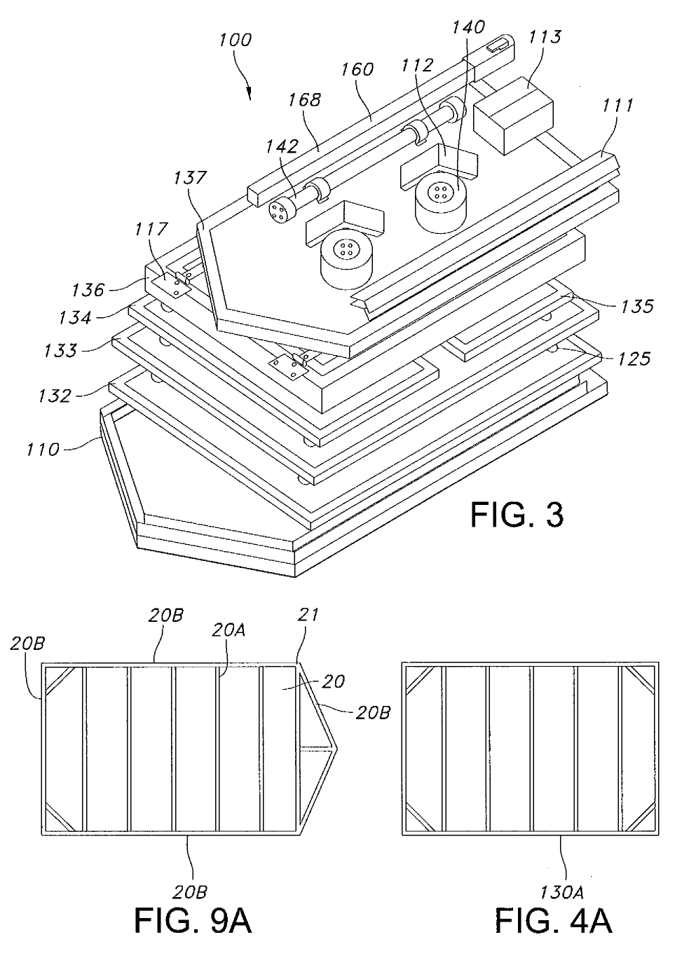

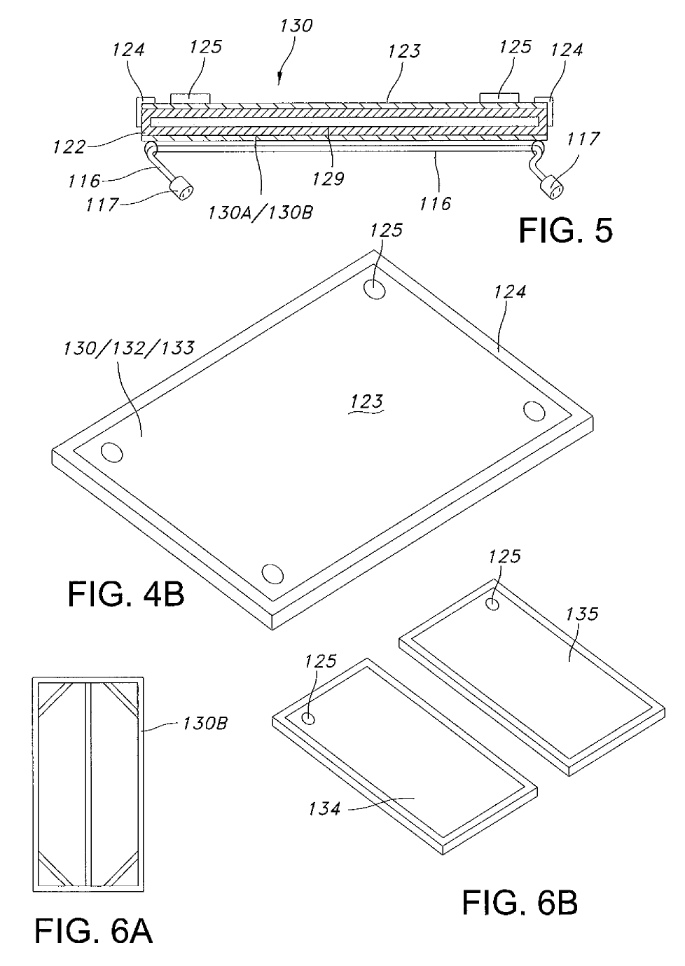

FIGS. 4A-6B illustrate the construction of the wall panels 130. The side panels 132 and 133 and the front-wall panels 134 and 135 are constructed similarly, but differ in size and shape. Each wall panel has a frame to which an exterior panel and an interior panel are attached. FIG. 4A shows a side panel frame 130A for the side panels 132, 133 and FIG. 6A a front-wall panel frame 130B for the front-wall panels 134, 135. An interior panel 122 and an exterior panel 123 are securely affixed to the frames 130A and 130B. The exterior edges of the panels 130 that abut each other are sealed and trimmed with trim angle pieces 124. Safety reflectors 125 are mounted on the panels 130 as shown in the figures. Also shown in FIG. 5 is insulative material that may be incorporated into the wall panels 130, if desired. An interconnecting wiring harness 116 is mounted to the interior panel 122. In the embodiment shown, the wiring harness 116 is laid out along the top of one or both of the side panels 132 and 133 and down to the lower front corner, where it passes through an opening in the floor and extends to the front of the tow assembly 160. Each end of the wiring harness 116 terminates in a conventional electrical connector 117. The wiring harness 116 connects the moving vehicle signal lights 150 to the tow vehicle power supply, as well as any other light fixtures that may be provided on the various panels.

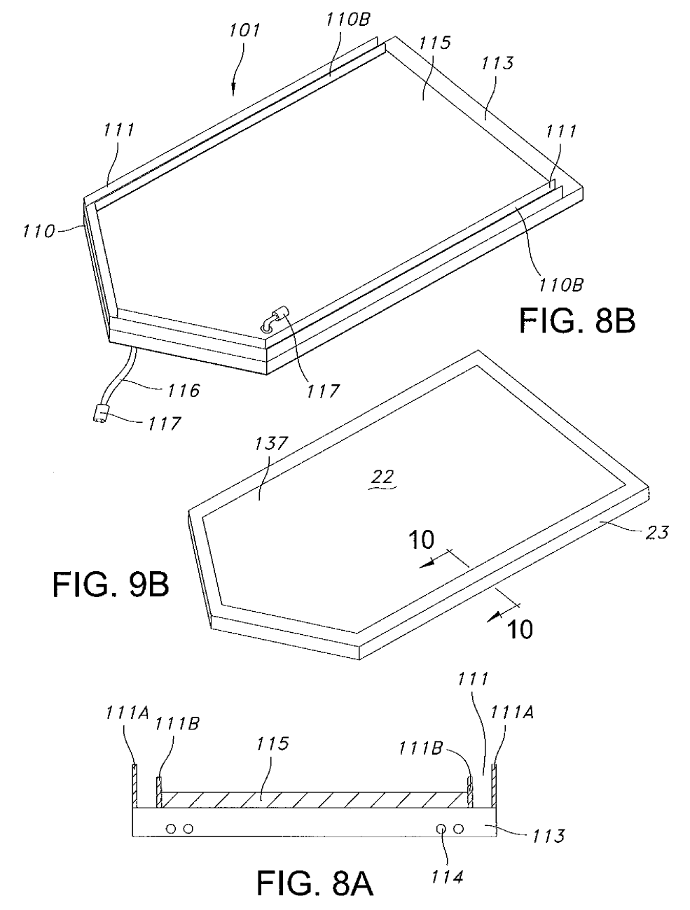

FIGS. 7A, 7B, 7C, 7D, and 8A and 8B illustrate the chassis 101, which comprises a chassis frame 110 having a first wall-panel receiving channel 111 along the upper edges of the frame 110, formed by two flanges 111A and 111B. The rear of the chassis frame 110 ends in an access-panel-mounting strut 113 having a set of access-panel-mounting holes 114. FIG. 7A shows the chassis frame 110, constructed of transverse chassis frame members 110A and long chassis frame members 110B. 7C shows a cross-section of the long chassis frame member 110B, showing the first wall-panel receiving channel 111. Transverse chassis members that form the outer ends of the chassis frame also have this first wall-panel receiving channel 111, so that this channel extends around the perimeter of the chassis frame 110. FIG. 7C is a cross-sectional illustration of the chassis 110. A floor 115 is placed on the upper side of the chassis frame 110 within the area defined by the long chassis frame members 110B and secured to the long frame members 110B by some conventional fastener means 2. Also indicated with dashed lines in FIG. 7C, is a wall panel 130 fitted into the first wall-panel receiving channel 111, also secured with a fastener 2. FIG. 7D is a perspective view of the rear right corner of the channel member 110B and the access-mounting strut 113. In the embodiment shown, the long frame member 110B and the mounting strut 113 are welded together, as indicated by the zigzag lines. It is understood that other methods of securely and rigidly attaching the mounting strut 113 to the channel member 110B are within the scope of the invention. FIG. 8A is a partial cross-sectional view of the rear end of the chassis 101, showing the mounting strut 113 in plane view and the flooring 115 and the first panel-receiving channel 111 in cross-sectional view. FIG. 8B shows the chassis 101 with flooring 115 filling out the area between the long frame members 110B and the mounting strut 113. A wiring harness 116 for connecting electrical lights or other devices to an electrical connector from the towing vehicle extends up through the floor 115 and ends with a connector 117. The other end of the wiring harness 116 is left free for connecting to wiring from the towing vehicle.

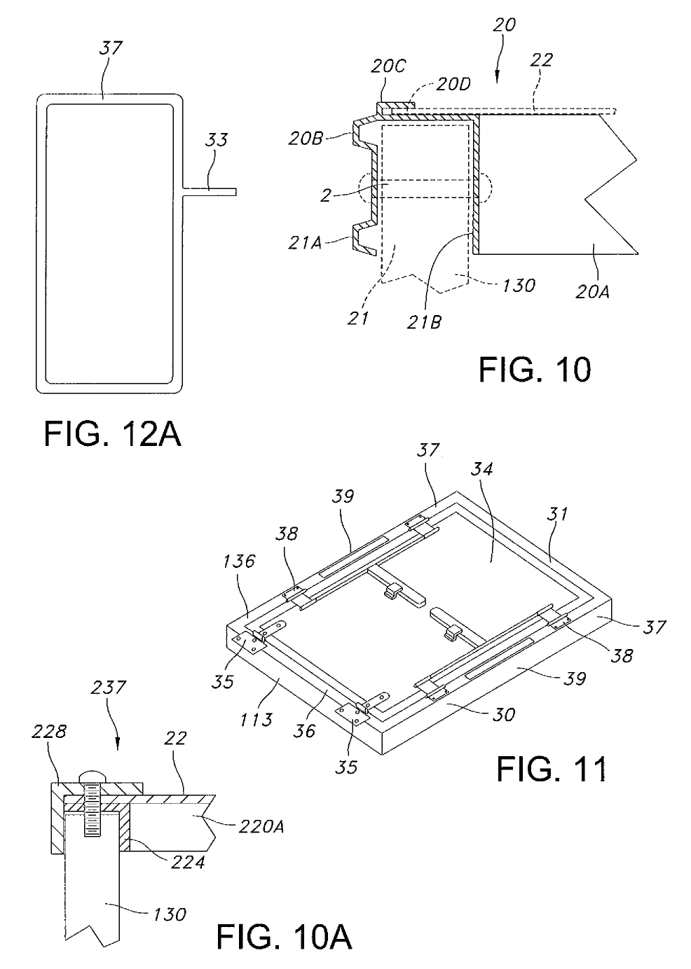

FIGS. 9A, 9B, and 10 illustrate the roof panel 137. FIG. 9A shows a roof-panel frame 20, constructed of exterior frame members 20B and, optionally, interior frame members 20A. The exterior frame members 20B define the perimeter of the roof frame 20. FIG. 9B shows the complete pre-fabricated roof panel. FIG. 10 shows the cross-section of the roof panel 137, showing the channel construction of the exterior roof-frame member 20B. A second wall-panel receiving channel 21 is formed by an outer flange 21A and an inner flange 21B on the exterior roof-frame members 20B, so that the second wall-panel receiving channel 21 extends around the entire perimeter of the frame 20. In the embodiment shown in these Figures, two parallel exterior frame members 20B further have a horizontal short flange 20C that forms a channel 20D for receiving an exterior roof panel or skin 22. Also indicated in dashed lines is one wall panel 130, which is fitted into the second wall-panel receiving channel 21 and secured by means of a fastener to the channel frame member 20B.

FIG. 10A shows a cross-sectional view of an alternative embodiment of a roof panel assembly 237, which includes a roof frame 220 plus roof skin 22 and roof trim 228. The roof frame 220 is constructed of exterior roof-frame members 224 and optionally interior transverse roof-frame members 220A. These exterior roof-frame members 224 are L-shaped, having a horizontal flange 226 that is dimensioned to receive and cover the upper edge of the wall panels 130. This horizontal flange 226 extends around the entire perimeter of the roof-panel frame 220. A second wall-panel receiving channel 221 is formed by the horizontal flange 226 and roof trim 228. When the trailer box is being assembled, the lower edges of the wall panels 130 are placed in the first wall-panel receiving channel 111. The roof panel 237 is then placed over the upper edges of the wall panels 130 so that the horizontal flange 226 extends over the upper edge of the wall panels. Roof trim 228 is assembled over the joint formed where the roof-panel assembly 237 and the wall panel 130 come together and fastened in place to the exterior roof-frame members 224.

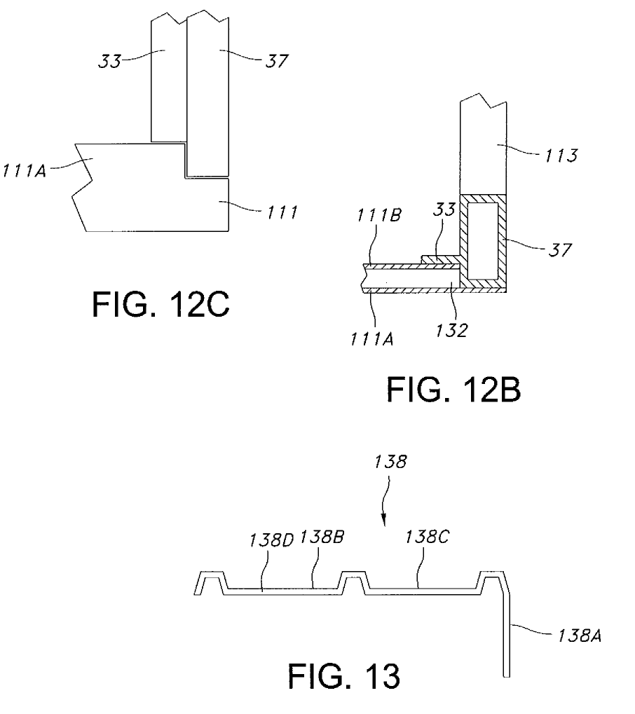

FIGS. 11-12 C illustrate components for the rear of the cargo trailer 200. FIG. 11 is a perspective view of the rear access panel 136, which comprises a rear-panel frame 30 having a lower beam 35, two side beams 37, and an upper beam 31, which together define an access way 32 into the assembled box 120. FIGS. 12A-12C illustrate details of the side beam 37, which has a side-panel support flange 33. A door 34 is mounted within the frame 30. In the embodiment shown, the door 34 is a drop-down door that is secured to the side beams 37 by safety locks 38. When assembled onto the cargo trailer 200, the door hinges 35 are bolted to the rear-access strut 113 through the mounting holes 114. It is understood that the door 34 may be any type of door suitable for the intended use of the cargo trailer 200, such as a side-opening door or a door that slides upward. Tail lights 39 are mounted into each side beam 37. A tail-light wiring harness is laid out along the interior side 41 of the rear-panel frame 30 in conventional manner.

FIG. 13 illustrates a rub rail 138 that is affixed to the rear end of the cargo trailer 200, to secure and seal the rear end of the side panels 132 and 133 to the door panel 137. The rail rub 138 has a first flange 138A that, when assembled, extends across a portion of the side beam 37 and a second flange 138B that extends across a rear edge of the side panel 132/133. As shown in FIG. 1, two rows of fasteners 138C and 138D are used to fasten the second flange 138B to the respective side panel 132/133. The first flange 138A, shown in FIG. 2, is fastened to the side beam 37.

To assemble the cargo trailer 200 from the cargo trailer kit 100, the axle assembly 142 is first attached to the underside of the chassis 110 and the tow bar 168 bolted to the underside of the chassis 110, such that the tow bar 168 extends forward from the chassis 110. The wiring harness 116 that connects moving vehicle signal lights 150 to a wiring harness from the towing vehicle is secured along the tow bar 168. The chassis is then turned right side up and set on blocks. The lower beam 35 of the rear access wall panel 136 is bolted, welded, or otherwise rigidly affixed to the access-panel mounting strut 113. The lower edge of each side panel 132, 133 is inserted into the first panel-receiving channel 111 of the chassis 110 and the rear end of the side panel abutted up against the side beams 37, such that the panel support flange provides support for the side panel. The rub rail 138 is fastened to the side panels 132, 133 and the side beams 37. The lower edge of each of the front panels 134 and 135 is then inserted into corresponding sections of the first wall-panel receiving channel 111. Once all side panels 130 are mounted in the first wall-panel receiving channel 111, the roof panel 137 is assembled on top of the side panels 130 and the rear-access panel 136, such that the second wall-panel receiving channel 21 fits over the upper edges of all of the panels that form the sides of the box 120: the rear access panel 136, the side panels 132 and 133, and the front panels 134 and 135. Fasteners are fastened to the outer flange 21A and the inner flange 21B, to secure the panels 130 to the roof panel 137 and through the flanges 11A and 111B on the channel members 110B to secure them to the chassis 101. If the alternative embodiment of the roof panel 237 is used, the second wall-receiving channel 221 for receiving and securing the wall panels 130 is accomplished in a two-step process: the roof panel 237 is fitted over the upper edges of all the panels 130, the roof trim 228 placed over the roof panel edge, so as to cover the upper edge of the wall panel 130, and the roof trim 228 then fastened to the exterior roof-frame members 224. A finishing strip 111 is affixed to adjacent side panels 130, as shown in FIG. 1, to cover up a gap formed by abutting side panels. A wheel-mounted tire 144 is mounted to each end of the axle assembly 142, and a fender 112 is mounted to the side walls 132 and 133 over each wheel-mounted tire 144 The wiring harnesses 116 are connected together with electrical connectors 117. The cargo trailer 200 is now completely assembled and ready to be hitched to a towing vehicle.

The frames for the wall panels, the roof panel, and the chassis are preferably made of aluminum. Tubular members are welded together to form the desired shape. Fasteners are used to secure the various panels to the frames. These fasteners may be self-threading screws that are drilled into the frames, or bolts that are inserted into pre-formed bolt holes.

It is understood that the embodiment described herein are merely illustrative of the present invention. Variations in the construction of the cargo trailer kit and its assembly may be contemplated by one skilled in the art without limiting the intended scope of the invention herein disclosed and as defined by the following claims.

What is claimed is:

1. A cargo trailer kit for assembly of a cargo trailer that is adapted for towing behind a tow vehicle, said cargo trailer kit comprising:
box assembly components, a wiring harness, and a wheel assembly,
wherein said box assembly components include pre-fabricated ready-to-assembly panels for constructing a cargo trailer box, said panels including a chassis with floor, a plurality of wall panels, and a roof panel;
wherein said wall panels have an upper edge and a lower edge and said chassis has a first channel for receiving said lower edge of said wall panels and said roof panel has a second channel for receiving said upper edge of said wall panels;
wherein at least one of said ready-to-assemble panels includes moving vehicle signal lights that are connectible to said wiring harness, said wiring harness being adapted for providing an electrical connection to a power supply on said tow vehicle;
wherein said box assembly components are assemblable to a cargo trailer box by capturing said upper edge and said lower edge of said wall panels within said first channel and said second channel and securing said wall panels with said first and second channels with threaded fasteners.

2. The cargo trailer kit of claim 1, further comprising a tow assembly that is assemblable on said chassis and adapted for connecting to a tow hitch on said tow vehicle.

3. The cargo trailer kit of claim 1, wherein said ready-to-assemble components are stackable upon each other, to form a compact volume for shipping.

4. The cargo trailer kit of claim 1, wherein said roof panel includes a roof-panel frame and an exterior roof skin that is affixed to said roof-panel frame, and further comprising roof trim, wherein said roof-panel frame comprises exterior roof-frame members that define a perimeter of said roof frame, said roof-frame members having a horizontal flange that extends about said perimeter of said roof frame and is dimensioned to receive said upper edge of said wall panels, and wherein said second channel for receiving said upper edge of said wall panel is formed when said roof trim is placed over a joint seam formed by said upper edge of said wall panel and said roof frame.

5. The cargo trailer kit of claim 1, wherein said roof panel includes a roof-panel frame and an exterior roof skin that is affixed to said roof-panel frame, wherein said roof-panel frame comprises exterior roof-frame members, each exterior roof-frame member being formed as a U-shaped channel that serves as said second channel.

6. The cargo trailer kit of claim 1, wherein one of said wall panels is an access panel that includes a door frame and a door assembled within said door frame.

7. The cargo trailer kit of claim 1, wherein said chassis with floor includes a chassis frame formed by outer chassis frame members, wherein said outer chassis-frame members include a support member having two flanges that extend vertically from an upper surface of said support member to form said first channel for receiving said lower edge of said wall panels, said first channel extending around a perimeter of said chassis frame, and wherein flooring is attached to said chassis between said outer chassis-frame members.

8. The cargo trailer kit of claim 7, said chassis further comprising a mounting strut that is permanently attached to a rear end of said chassis frame.

9. The cargo trailer kit of claim 7, wherein said wiring harness is provided in said chassis, with a first end of said wiring harness adapted for connecting to moving vehicle signal lights when said cargo trailer box is assembled, said first end extending through an aperture in said floor onto an upper surface of said floor, and with a second end of said wiring harness adapted for connecting to wiring from said tow vehicle, said second end of said wiring harness extending out from under said chassis toward a front end of said chassis.
